(19) United States
(12) Patent Application Publication
(10) Pub. No.: US 2017/0371701 A1
(43) Pub. Date: Dec. 28, 2017

(54) APPARATUSES, METHODS, AND SYSTEMS FOR GRANULAR AND ADAPTIVE HARDWARE TRANSACTIONAL SYNCHRONIZATION

(71) Applicants: KSHITIJ A. DOSHI, Tempe, AZ (US); CHRISTOPHER J. HUGHES, Santa Clara, CA (US)

(72) Inventors: KSHITIJ A. DOSHI, Tempe, AZ (US); CHRISTOPHER J. HUGHES, Santa Clara, CA (US)

(21) Appl. No.: 15/194,226

(22) Filed: Jun. 27, 2016

(51) Int. Cl. G06F 9/46; G06F 3/06

(52) U.S. Cl. CPC G06F 9/467; G06F 3/0673; G06F 3/061; G06F 3/0637

(57) ABSTRACT

Methods and apparatuses relating to hardware transactions are described. In one embodiment, a processor includes one or more cores to concurrently execute a plurality of transactions, and a hardware transactional circuit to detect an occurrence of a software selected precursor in any of the plurality of transactions and abort at least one of the plurality of transactions on the occurrence unless an interface to software indicates the occurrence is to not cause an abort, wherein the occurrence is not a memory access of shared data by the plurality of transactions.

### TECHNICAL FIELD

The disclosure relates generally to electronics, and, more specifically, an embodiment of the disclosure relates to a processor with a hardware transactional circuit.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a processor according to embodiments of the disclosure.

FIG. 2 illustrates a processor according to embodiments of the disclosure.

FIG. 3A illustrates a processor before a software selected precursor occurs according to embodiments of the disclosure.

FIG. 3B illustrates the processor of FIG. 3A after the software selected precursor occurs according to embodiments of the disclosure.

FIG. 4A illustrates a processor before a software selected precursor occurs according to embodiments of the disclosure.

FIG. 4B illustrates the processor of FIG. 4A after the software selected precursor occurs according to embodiments of the disclosure.

FIG. 5A illustrates a processor before a software selected precursor occurs according to embodiments of the disclosure.

FIG. 5B illustrates the processor of FIG. 5A after the software selected precursor occurs according to embodiments of the disclosure.

FIG. 6A illustrates a processor before a software selected precursor occurs according to embodiments of the disclosure.

FIG. 6B illustrates the processor of FIG. 6A after the software selected precursor occurs according to embodiments of the disclosure.

FIG. 7A illustrates a processor before a software selected precursor occurs according to embodiments of the disclosure.

FIG. 7B illustrates the processor of FIG. 7A after the software selected precursor occurs according to embodiments of the disclosure.

FIG. 8A illustrates a processor before a software selected precursor occurs according to embodiments of the disclosure.

FIG. 8B illustrates the processor of FIG. 8A after the software selected precursor occurs according to embodiments of the disclosure.

FIGS. 9A-9B illustrate precursors according to embodiments of the disclosure.

FIG. 10 illustrates a flow diagram according to embodiments of the disclosure.

FIG. 11A is a block diagram illustrating both an exemplary in-order pipeline and an exemplary register renaming, out-of-order issue/execution pipeline according to embodiments of the disclosure.

FIG. 11B is a block diagram illustrating both an exemplary embodiment of an in-order architecture core and an exemplary register renaming, out-of-order issue/execution architecture core to be included in a processor according to embodiments of the disclosure.

FIG. 12A is a block diagram of a single processor core, along with its connection to the on-die interconnect network and with its local subset of the Level 2 (L2) cache, according to embodiments of the disclosure.

FIG. 12B is an expanded view of part of the processor core in FIG. 12A according to embodiments of the disclosure.

FIG. 13 is a block diagram of a processor that may have more than one core, may have an integrated memory controller, and may have integrated graphics according to embodiments of the disclosure.

FIG. 14 is a block diagram of a system in accordance with one embodiment of the present disclosure.

FIG. 15 is a block diagram of a more specific exemplary system in accordance with an embodiment of the present disclosure.

FIG. 16, shown is a block diagram of a second more specific exemplary system in accordance with an embodiment of the present disclosure.

FIG. 17, shown is a block diagram of a system on a chip (SoC) in accordance with an embodiment of the present disclosure.

FIG. 18 is a block diagram contrasting the use of a software instruction converter to convert binary instructions in a source instruction set to binary instructions in a target instruction set according to embodiments of the disclosure.

### DETAILED DESCRIPTION

In the following description, numerous specific details are set forth. However, it is understood that embodiments of the disclosure may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A (e.g., hardware) processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decode unit (decoder) decoding macro-instructions. A processor (e.g., having one or more cores to decode and/or execute instructions) may operate on data, for example, in performing arithmetic, logic, or other functions.

An instruction or instructions to be executed may be separated into a plurality of transactions, e.g., for concurrent execution of multiple transactions. For example, instructions may be separated into different threads (e.g., threads of execution). A thread may generally refer to the smallest sequence (e.g., stream) of instructions that may be managed independently, e.g., by a scheduler, for execution. A scheduler may schedule execution of instructions of a thread on a core (or other execution resources) of the processor. A logical (e.g., virtual) thread may generally refer to the thread that is visible from (e.g., managed by) the code. Code may include software such as an operating system (OS). A physical thread may generally refer to the physical components of a processor (e.g., of a core thereof) that execute the logical thread.

In one embodiment, a transaction is guaranteed according to one, all, or any combination of atomicity, consistency, isolation, and durability (ACID) properties. Atomicity (e.g., being atomic) may generally refer to a transaction being “all or nothing”. For example, if one part of the transaction fails, then the entire transaction fails and the data that was operated on is left unchanged. An atomic system may guarantee atomicity in each and every situation, e.g., including power failures, errors, and crashes. In certain embodiments, outside of the transaction, a committed transaction appears (e.g., by its effects on the operated on data) to be indivisible (“atomic”) and an aborted transaction (e.g., not committed) appears to not have happened. In one embodiment, an abort of a transaction rolls back that transaction and discards (e.g., undoes) any changes made by that transaction. Consistency may generally refer to any transaction that is to bring the data from one valid state to another. For example, any written data is to be valid according to all defined rules, e.g., including constraints, cascades, triggers, and any combinations thereof. This may not guarantee correctness of the transaction in all ways, e.g., that may be the responsibility of application-level code, but may guarantee that any programming errors will not result in the violation of any defined rules. Isolation may generally refer to concurrent execution of transactions (e.g., threads) resulting in a same system state that would have been obtained if those transactions were executed serially, e.g., one after the other. Concurrency control may provide isolation. For example, depending on the concurrency control method, the effects of an incomplete transaction may not be visible to other transaction(s). Durability may generally refer to once a transaction has been committed, it is to remain so, e.g., even in the event of power loss, crashes, or errors. For example, to defend against power loss, transactions (or their effects) may be recorded in a non-volatile (e.g., persistent) memory. When used in conjunction with either software or hardware transactional memory approaches, e.g., in contrast to a database transaction, durability may be generally obtained by external means such as logging the results of a transaction to durable media before volatile memory pages from a transaction are reflected to the durable media.

Hardware transactional memory (HTM) circuitry may provide for coordination among threads so that they can execute in parallel, for example, even when they have the potential to perform conflicting memory operations. In certain embodiments, a conflicting memory operation is when two transactions (e.g., threads) are to access shared data. In certain embodiments, a processor (e.g., a central processing unit (CPU)) monitors (e.g., looks) for conflicts among memory accesses across threads, e.g., and revectors threads in transactional execution to designated safe points automatically when a memory access conflict arises (e.g., when one thread tries to read the speculative write of another thread). Thus, certain embodiments of HTM do not prevent concurrent execution of multiple transactions (e.g., threads) because of potential memory conflicts unless those potential memory conflicts turn into actual atomicity violations.

Additionally or alternatively to memory access conflicts, certain embodiments of this disclosure provide for the parameterization of transactional execution. For example, certain embodiments herein include hardware that gives software (e.g., some) control over the rules for aborting transaction(s). Certain embodiments herein include hardware that allows software to use transactions to provide features beyond speculative concurrent execution, e.g., beyond memory access conflicts. Certain embodiments herein include hardware for granular and adaptive hardware transactional synchronization. Certain embodiment herein provide for enhanced hardware transactional circuits and methods, e.g., with precursors (e.g., events) that trigger aborts, such as, but not limited to, TLB invalidations, and precursor (e.g., event) masks (for example, held in a register (e.g., MSR)) that let software select which precursor (e.g., event) or combination of precursors (e.g., events) are to trigger an abort. Certain embodiments herein allow usages for hardware transactional circuits beyond speculative parallelization. Certain embodiments herein provide processor technology and support for hardware transactional synchronization, e.g., with cache and microarchitectural state management and coherence, and/or varying isolation models. Certain embodiments herein are not purely in software, e.g., certain embodiments herein have a lower price in both performance and programmer productivity than pure software. Certain embodiments herein make parallel programming easier. Certain embodiments herein provide for enhanced HTM circuits and methods with the (e.g., software) selectable ability to abort an HTM transaction, e.g., under various conditions. One example is to have the option to abort an HTM transaction when it encounters a cache miss, for example, to provide for the ability to implement snapshot isolation, e.g., have transactions that cannot read new data once they have started, and thus guaranteeing they have a consistent view of memory without additional synchronization.

Below are two non-limiting examples to illustrate how certain embodiments herein allow for more flexible rules for causing an abort. Consider the case of two threads (T1 and T2) both executing transactions (e.g., on a single node). In one embodiment, hardware transactional memory (HTM) circuitry will abort T1 if: (1) T1 has previously read a cache line (C) and T2 then writes to C, or (2) T1 has previously written C and T2 then reads or writes C. In certain embodiments, the cache (e.g., cache memory) may be part of the core or separate, or both (e.g., in a multiple level cache).

In a first example, a processing system (e.g., cluster) accesses a distributed shared memory, e.g., with silicon photonics. In such a system, coherence may be provided across nodes at region granularity, e.g., where a region is one or more pages in a page table (e.g., pages of virtual address to physical address mapping). In one embodiment, this coherence may be enforced via changes in a page table entry's state bits, for example, which are (e.g., automatically) propagated across nodes. In this first example, a hardware transactional circuit protects data in the global address space, e.g., if T1 and T2 access the same region in a conflicting way, the hardware is to detect this and abort (e.g., cause the abort of) one of the transactions, for example, by triggering an abort on the detection of a change(s) to page metadata.

In a second example, a processing system accesses three dimensional (3D) memory, such as, but not limited to, multi-channel dynamic random-access memory (MCDRAM) or high bandwidth memory (HBM). For example, certain embodiments may include systems with a very large capacity main memory and a separate (e.g., high bandwidth) memory tier close to the processor (e.g., CPUs). In one embodiment, software controls where data sits between these two memories by remapping virtual pages (e.g., keeping the same virtual address (VADDR)) to different physical page frames to move (e.g., hot) data closer to the processor (e.g., CPU). In one embodiment, to minimize synchronous translation lookaside buffer (TLB) shootdowns, a hardware transactional circuit performs eager unmapping of pages without TLB flushes in one tier and then move those pages to the next tier. In certain embodiments thereof, there may be a short interval of exposure where a data race may occur between two threads that happen to refer to the same virtual address (e.g., cache line) with two different physical addresses. That may happen because one or more of the cores' TLB holds a stale translation. If accesses to shared data objects are protected with a hardware transactional circuit, for example, by aborting transactions on a page table entry (PTE) state change (e.g., in addition to data changes), there is an efficient, non-intrusive alternative to exposing software to the responsibility of handling this corner case.

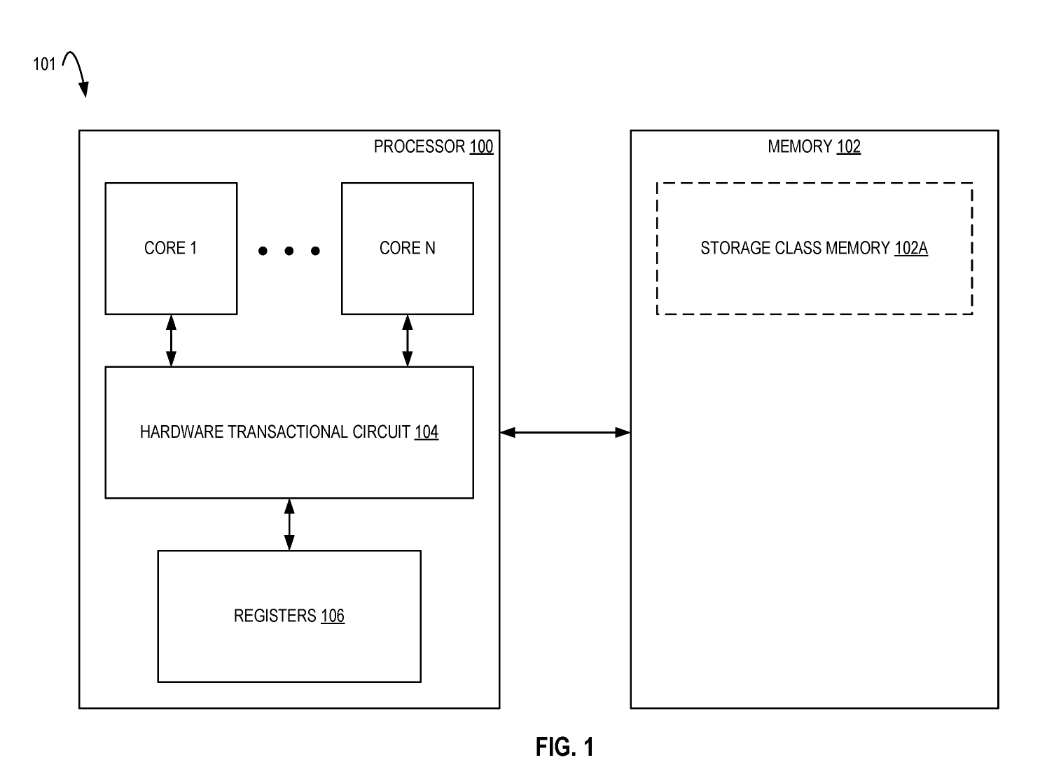

FIG. 1 illustrates a processor 100 according to embodiments of the disclosure. Processor 100 may include one or more cores. Processor may be a component in a computing system 101. Processor, e.g., core or a memory management unit (MMU) (not depicted), may access memory 102 (e.g., optional storage class memory 102A). Processor may include one or more components, e.g., discussed below. Depicted processor 100 includes registers 106, for example, a control register or registers to control (e.g., and/or allow software to control) certain features of the hardware. In one embodiment, other software interface(s) to hardware may be utilized.

Hardware processor 100 may execute instructions (e.g., stored in memory 102) to operate on data, for example, to perform arithmetic, logic, or other functions. A hardware processor may access data in a memory. In one embodiment, a hardware processor is a client requesting access to (e.g., load or store) data and the memory is a server containing the data. In one embodiment, a computer includes a hardware processor requesting access to (e.g., load or store) data and the memory is local to the computer. Memory 02 may be system memory. Memory 102 may store software that executes on the processor 100.

Note that the figures herein may not depict all data communication connections. One of ordinary skill in the art will appreciate that this is to not obscure certain details in the figures. Note that a double headed arrow in the figures may not require two-way communication, for example, it may indicate one-way communication (e.g., to or from that component or device). Any or all combinations of communications paths may be utilized in certain embodiments herein.

Depicted processor 100 includes a hardware transactional circuit 104. In one embodiment, a hardware transactional circuit (e.g., including hardware logic circuitry) is a component of a processor (e.g., a memory management unit) or a system on a chip (SoC). A hardware transactional circuit (e.g., including hardware logic circuitry) may be a component of a processor in a computer, server, etc. In certain embodiments, a hardware transactional circuit is to detect an (e.g., each) occurrence of a (e.g., software selected) precursor. In certain embodiments, a hardware transaction circuit (e.g., hardware transactional execution circuit) and/or registers are disposed within a (e.g., each) core.

In certain embodiments, a hardware transactional circuit includes one or a plurality of hardware transactional precursor (e.g., event) masks and the ability to set (e.g., via software) the hardware to abort (and/or perform other actions) based on the occurrence of the precursor (e.g., event) or series of precursors (e.g., events). In certain embodiments, for each precursor (e.g., event or condition) that is being monitored for its occurrence, one or more of the following options may be achieved by the hardware (e.g., as set or determined by the software): (1) nothing; (2) detect and log (e.g., in a register or other memory) the occurrence of the precursor (e.g., event or events) (for example, in a flag register) during a (e.g., each) transaction. In one embodiment, a particular transaction(s) (e.g., a thread) is marked (e.g., by the hardware and/or software) to be monitored for the occurrence of the precursor (e.g., event); (3) detect the occurrence of the precursor (e.g., event) and abort unless (e.g., the software) has excluded the precursor (e.g., event) from causing an abort (e.g., using a second mask), e.g., software may check the flag(s) register before committing or aborting the transaction; and (4), detect and add the occurrence of the precursor (e.g., event) to the flags register and abort the transaction if the new value of the flag(s) register matches a set of conditions, e.g., updated and/or set by software.

Option (1) may ensure that only the hardware is burdened with the detection of a precursor (e.g., event) when software is to utilize the occurrence, for example, there may not be a need to track cache misses unless snapshot isolation is desired. Option (2) may let the software take control (e.g., after the occurrence of a precursor) of the decision if the transaction(s) (e.g., where the precursor occurred) should commit or abort, for example, once the software has reached a certain point in the execution and may check and clear the flags register if some combinations of events have not arisen until that point. Option (3) may allow the software to (e.g., entirely) delegate to hardware the control to abort a transaction for any (e.g., pre-selected) precursor (e.g., event), e.g., where there is minimal benefit for the software to take on the extra cycles to check and decide otherwise. Option (4) may allow software to abort a transaction only when a defined group of precursors (e.g., events or conditions) arises together, e.g., and vary what is in that group as it makes progress.

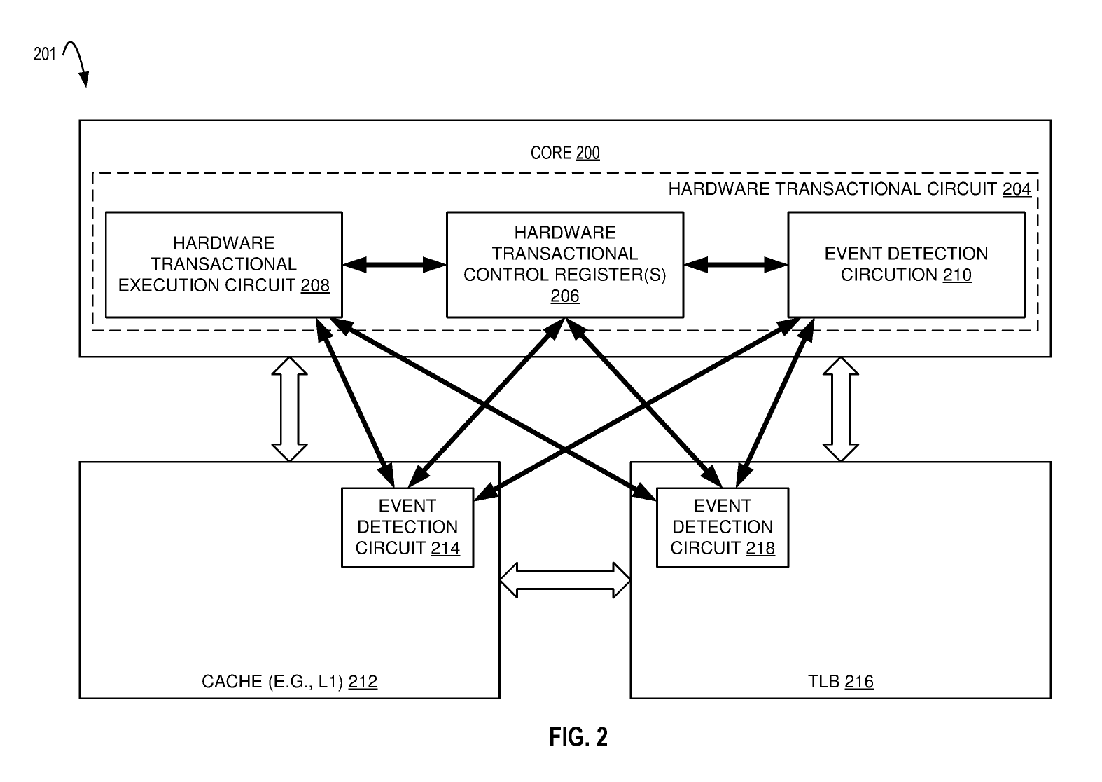

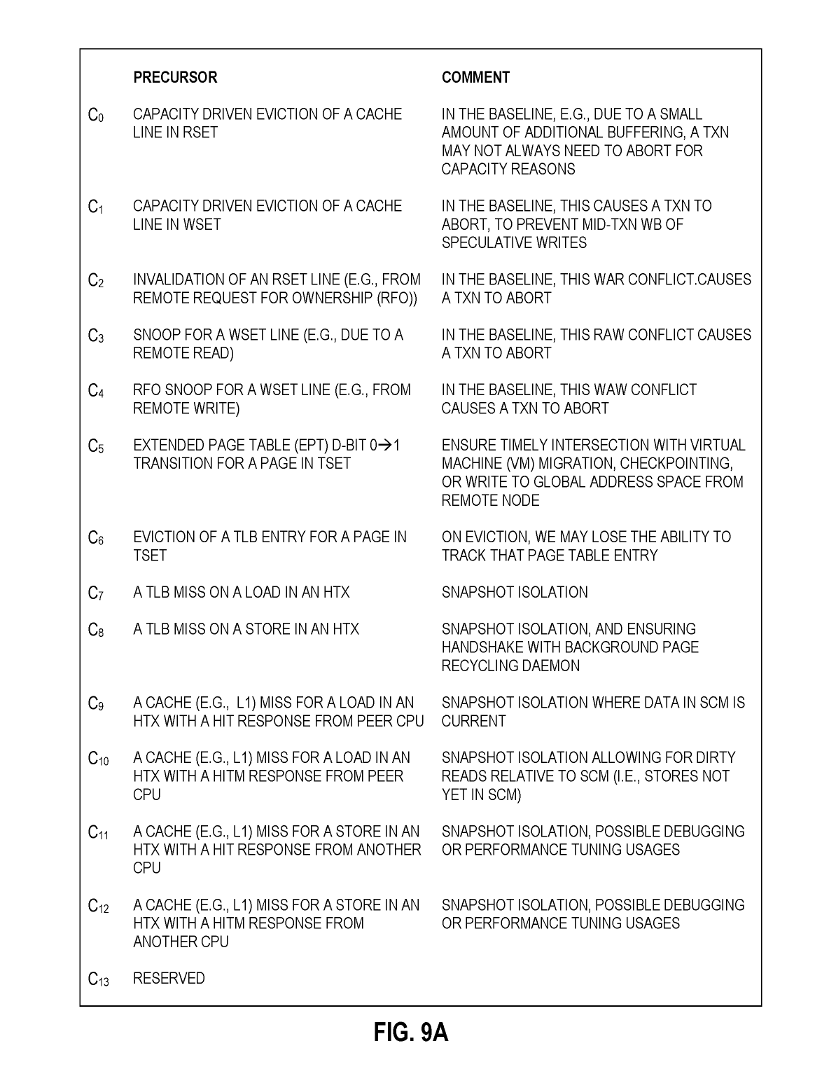

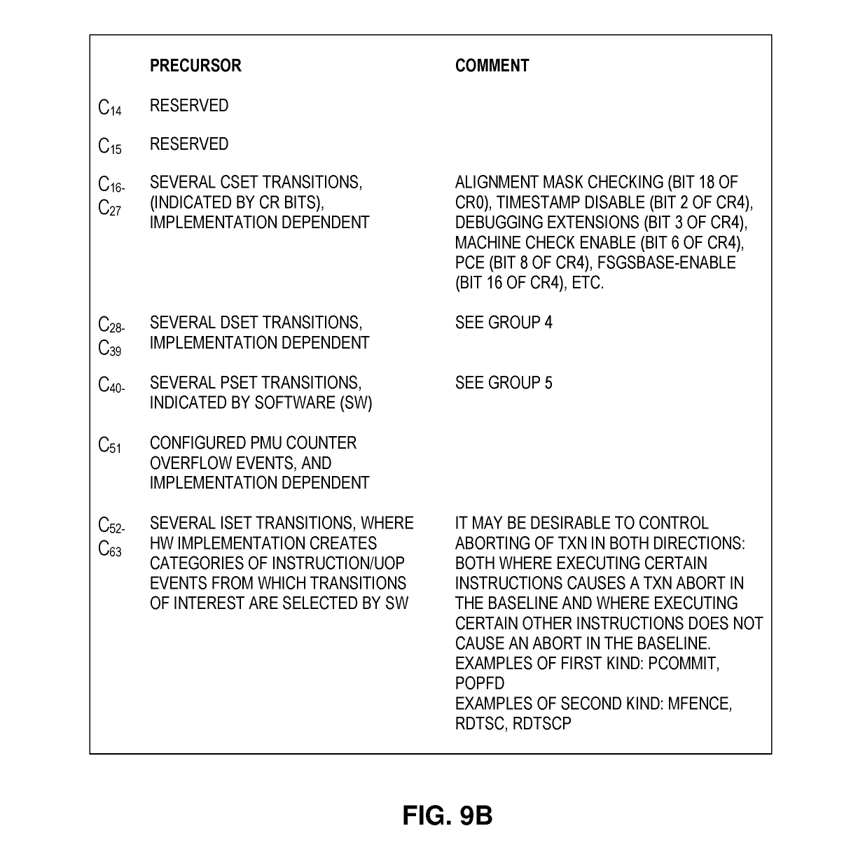

FIG. 2 illustrates a processor 201 according to embodiments of the disclosure. Although the hardware transactional circuit 204 is depicted in core 200, the hardware component(s) may be disposed (e.g., distributed) in a processor, system, etc. Processor 201 may include a decoder (e.g., decode unit) and an execution unit. Depicted core 200 is coupled (e.g., connected) to cache 212 (e.g., a L1 or L2 or other level cache). Core 200 includes event detection circuit 210. In certain embodiments, an event detection circuit detects any event or events pertaining to or relating to a precursor. Depicted cache 212 includes event detection circuit 214. Depicted core 200 is coupled (e.g., connected) to translation lookaside buffer (TLB) 216. Depicted TLB 216 includes event detection circuit 218. Although shown as distributed, event detection circuit may be centralized. Event detection circuit may detect one or more types of events, for example, those discussed in reference to FIGS. 9A-9B below. For example, event detection circuit may send a notification when the alignment mask checking bit of a control register (e.g., CR0) is altered.

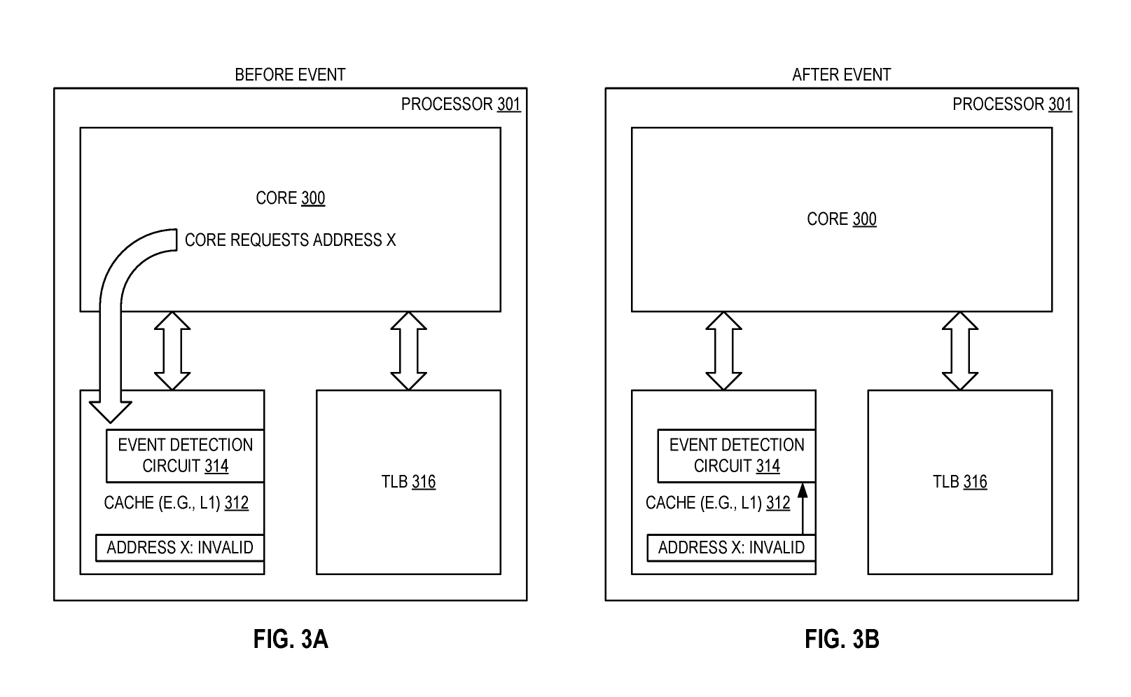

Core 200 includes hardware transactional control register(s) 206, e.g., to allow the software to control the hardware transactional operations. In one embodiment discussed below, a plurality of hardware transactional control registers are utilized. Depicted core 200 includes hardware transactional execution circuit 208. In one embodiment, hardware transactional execution circuit 208 is to perform the commit or abort of a transaction, e.g., according to this disclosure. Certain embodiments herein couple (e.g., connect) the event detection hardware (e.g., circuits) to a hardware transactional execution circuit, e.g., to detect an event and take (or not take) action(s) based on the event. The following is a discussion of six groups of precursors in reference to FIGS. 3A-8B, but the disclosure is not so limited. These six example groups of precursors (e.g., events) are (1) cache hierarchy events, (2) memory management events, (3) architectural events and state changes, (4) device communications (e.g., non-interrupting), (5) performance and/or debugging interest, and (6) execution of special instructions. Although event detection circuits are shown in certain components in the Figures below, certain embodiments may utilize other locations for the event detection circuit(s).

### Group 1: Cache Hierarchy Events

Hardware transactional circuit may flexibly abort a transaction on a variety of MESI transitions and evictions of cache lines, for example, according to a cache coherence protocol, such as, but not limited to, the four state modified (M), exclusive (E), shared (S), and invalid (I) (MESI) protocol or the five state modified (M), exclusive (E), shared (S), invalid (I), and forward (F) (MESIF) protocol, e.g., E/M/S to I transitions, E/S to M transitions, M/E to S transitions, I to E/S transitions, etc. For example, embodiments of a hardware transactional circuit herein may allow more flexibility than a (e.g., HTM) transaction that does not abort except in the case of detection of read/write or write/write conflicts with other cores (e.g., CPUs), for example, E/M/S to I transitions for cache line(s) accessed during a transaction. Certain embodiments herein allow for the abort of a transaction in the event of a (e.g., L1) cache miss, for example, the hardware lets the software achieve snapshot isolation e.g., the only data available for consumption without causing an abort is what was in the cache at the start of the transaction (e.g., at a snapshot in time). In one embodiment of a hardware transactional circuit to support snapshot isolation under hardware transactions, the (e.g., L1) cache may be divided between hardware transactional threads or the hardware transactional circuit may disable hardware transactional tracking and/or actions for the duration of the transaction. In one embodiment of an architecture that admits non-speculative loads and/or stores within a transaction over some ranges of memory, a hardware transactional circuit may also detect and abort transactions when write/write conflicts occur, e.g., and not abort on read/write conflicts. In certain embodiments, this may support weaker models (such as dirty reads) while guarding against non-deterministic ordering.

FIG. 3A illustrates a processor 301 before a software selected precursor (e.g., of a core 300 requesting an invalid cache line in cache 312 being detected by the event detection circuit 314) occurs according to embodiments of the disclosure. FIG. 3B illustrates the processor 301 of FIG. 3A after the software selected precursor occurs according to embodiments of the disclosure. The hardware transactional circuit (not depicted) may then take an action based on that detection, for example, any of the four options (1)-(4) discussed above. In the depicted embodiment, processor 301 includes a TLB 316.

### Group 2: Memory Management Events

Hardware transactional circuit may allow in its read-set any address translations (e.g., page table entries (PTEs)), for example, along with their associated metadata (e.g., protection keys, etc.), and thus includes PTE state changes in decisions to abort a transaction. In one embodiment, a memory management unit (MMU) may include an event detection circuit to detect changes (e.g., in metadata). In certain embodiments, including protection keys and metadata in PTEs as a monitored transaction event further allows hardware and/or software to include application managed tiering and failure-resilient durability in transaction commits. For example, to achieve failure resilient durability, an application may collect modifications in a volatile page until after a transaction's modifications have been reflected and committed into a write ahead log, and then change the translation from a volatile to a non-volatile shadow page to which the modifications are streamed and committed in the background. Certain embodiments herein detect any PTE (e.g., metadata) changes.

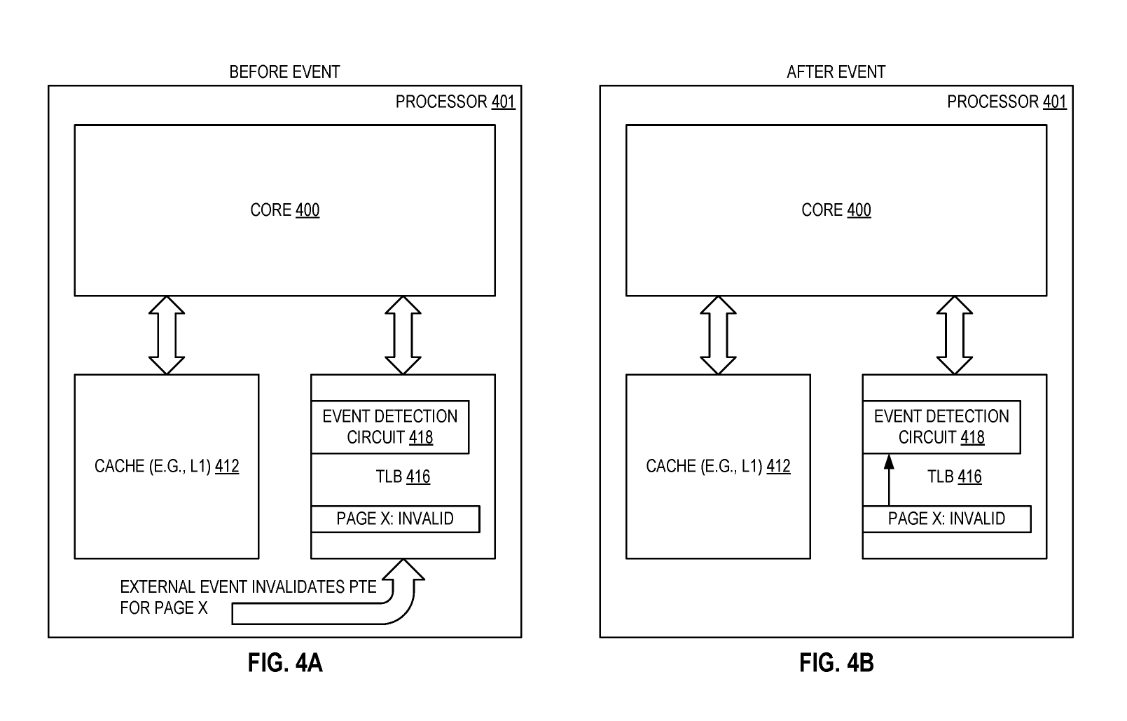

FIG. 4A illustrates a processor 401 (e.g., core 400) before a software selected precursor (for example, of an external event invalidating a page table entry for page X, e.g., as detected with event detection circuit 418 of TLB 416) occurs according to embodiments of the disclosure. FIG. 4B illustrates the processor 401 of FIG. 4A after the software selected precursor occurs according to embodiments of the disclosure. The hardware transactional circuit (not depicted) may then take an action based on that detection, for example, any of the four options (1)-(4) discussed above. In the depicted embodiment, processor 401 includes a cache 412.

### Group 3: Architectural Events and State Changes

This group of precursors (e.g., events) includes selected pieces of architectural state, for example, as captured in various registers, e.g., control registers or status registers (e.g., including RFLAGS). In one embodiment, a control register includes an alignment checking bit (e.g., bit 18 of control register CR0). It may be desired that a hardware transactional circuit does not detect and/or take a resultant action when alignment mask checking is enabled, e.g., so that a library function that is called downstream (e.g., in a third party library) from the transaction (e.g., only) produces accesses that are not going to cross cache lines. Certain embodiments herein may simplifying debugging, or reducing or bounding inadvertent side effects on performance. Similarly, debugging extensions (e.g., bit 3 of control register CR4) of the hardware transactional circuit may be used to prevent a transaction from continuing, e.g., when a write to a debug register (e.g., DR4 or DR5) is detected.

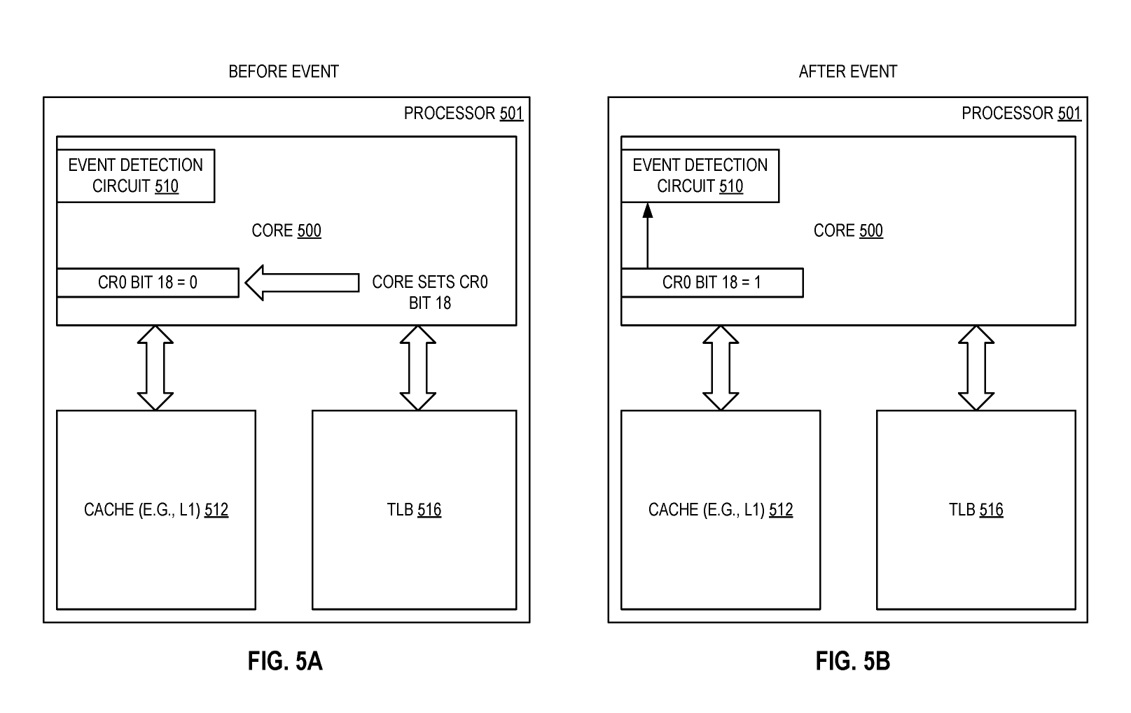

FIG. 5A illustrates a processor 501 before a software selected precursor (for example, setting of a control register bit, e.g., as detected with event detection circuit 510 of core 500) occurs according to embodiments of the disclosure. FIG. 5B illustrates the processor 501 of FIG. 5A after the software selected precursor occurs according to embodiments of the disclosure. The hardware transactional circuit (not depicted) may then take an action based on that detection, for example, any of the four options (1)-(4) discussed above. In the depicted embodiment, processor 501 includes a cache 512 and TLB 516.

### Group 4: Device Communications (e.g., Non-Interrupting)

In one embodiment, software has arranged for a device to communicate non-zero event queue lengths to a given core (e.g., CPU), for example, via status and/or flag bits. A hardware transactional circuit (e.g., a hardware transactional execution circuit thereof) may treat the status and/or flag bits as soft (e.g., pseudo) interrupts. That is, these precursors (e.g., events) are not true interrupts that abort a transaction. Instead, they may serve as indications that something of interest to software has occurred, for example, and the hardware transactional circuit (e.g., a hardware transactional execution circuit thereof) is to act on it variably, e.g., by taking an action based on that detection, for example, any of the four options (1)-(4) discussed above. In certain embodiments, polled device communications are used in (e.g., very high performance) drivers, such as a user-mode network connection driver, e.g., for 10 Gb and 40 Gb networks. User mode code may use such communications to implement virtual remote memory access protocols such that from an application's perspective, a library call is sufficient to have a peer to peer transfer of data between nodes. In addition to data transfer, this form of communication may also be useful in implementing light-weight, distributed synchronization, e.g., via reading/writing of ownership information about objects.

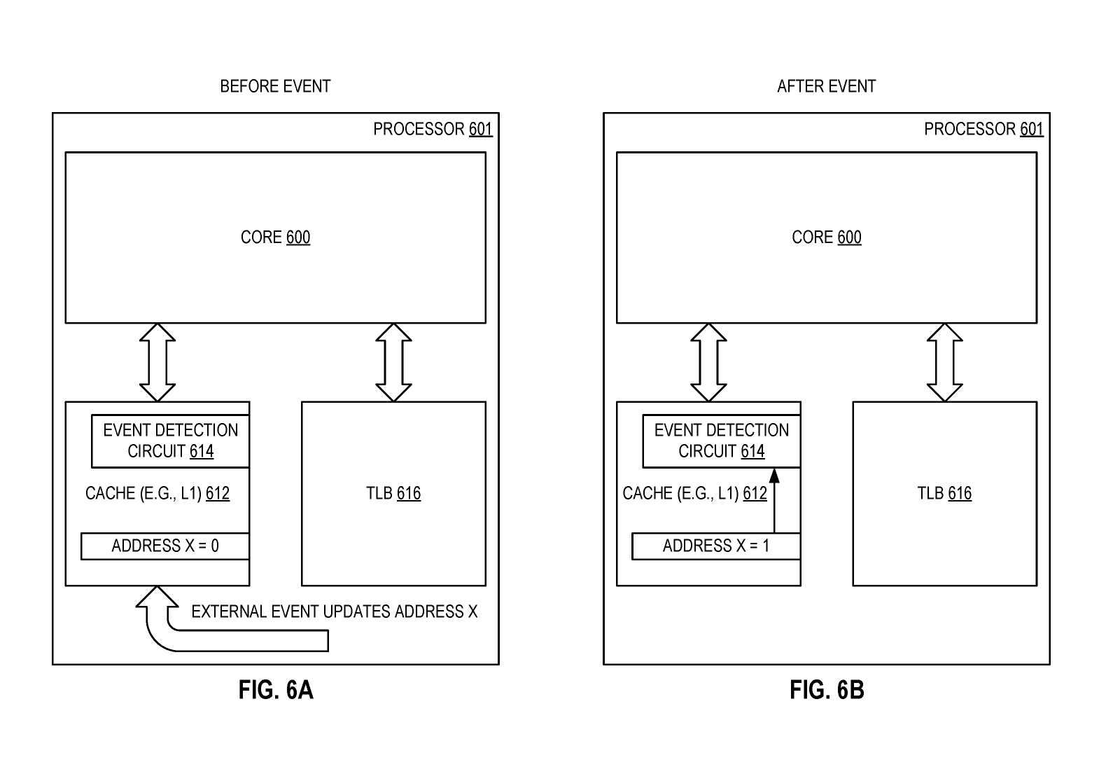

FIG. 6A illustrates a processor 601 (e.g., core 600) before a software selected precursor (for example, of an external event updating a cache line in the cache 612, e.g., as detected with event detection circuit 614) occurs according to embodiments of the disclosure. FIG. 6B illustrates the processor 601 of FIG. 6A after the software selected precursor occurs according to embodiments of the disclosure. The hardware transactional circuit (not depicted) may then take an action based on that detection, for example, any of the four options (1)-(4) discussed above. In the depicted embodiment, processor 601 includes a TLB 616.

Group 5: Performance and/or Debugging Interest

This group of precursors (e.g., events) may include events in the performance monitoring (PMON) unit of a processor (e.g., CPU). In one embodiment, a hardware transactional circuit is to not generate an interrupt on a performance counter overflow, for example, in an embodiment where a PMON unit generates status bits. These status bits may be monitored by the hardware transactional circuit and provide the ability for software to adapt. For example, at the start of a transaction to be monitored by the hardware transactional circuit, so long as the cache miss rate during the transaction is below a threshold (e.g., 2%) and/or the number of instructions in the transaction stays below a threshold (e.g., 50), the transaction may be allowed to proceed normally (e.g., without an abort). Certain embodiments of this allow for adaptive transactions in which software learns from and shapes its speculative execution in response to dynamic conditions and data.

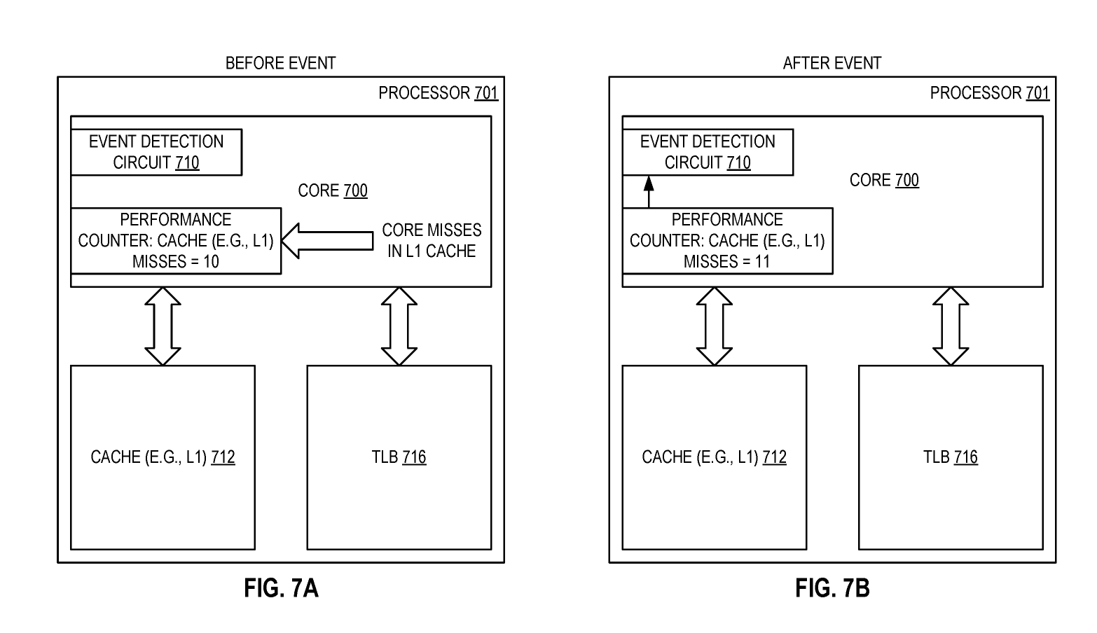

FIG. 7A illustrates a processor 701 before a software selected precursor (for example, of cache misses, e.g., as detected with event detection circuit 710 of core 700) occurs according to embodiments of the disclosure. FIG. 7B illustrates the processor 701 of FIG. 7A after the software selected precursor occurs according to embodiments of the disclosure. The hardware transactional circuit (not depicted) may then take an action based on that detection, for example, any of the four options (1)-(4) discussed above. In the depicted embodiment, processor 701 includes a cache 712 and TLB 716.

### Group 6: Execution of Special Instructions

In some embodiments, certain instruction(s) may always cause an abort of an HTM transaction. Certain embodiments herein allow these instruction to not always abort (e.g., optionally abort) e.g., to give software a better role in conditioning the decision to abort, log, or transparently permit the execution of such instructions. In one embodiment, it may be neither practical not useful to define a variety of outcomes across all instructions in an ISA, thus the instructions of the ISA may be divided them into two groups: one group consisting of the instructions that do not always cause an HTM transaction to abort, and the other consisting of the rest. The second group may then be subdivided into a number of subgroups, e.g., {{G₁}, {G₂} . . . {G}}. For each subgroup {G_{J}}, an instruction event, g_{J}, which is said to occur if an instruction j is a subset of {G_{J}} is executed. For each such transaction event g_{J} detected, the hardware transactional circuit may take an action based on that detection, for example, any of the four options (1)-(4) discussed above. For example, there may be uses of a no-operation (NOP) opcode that is targeted for a special core or processor. For example, for ensuring transparency of design, software may elect to abort when that instruction runs on a different (e.g., later generation) processor and finds that it is executing an opcode that was previously mapped to a NOP (e.g., and now is not a NOP instruction).

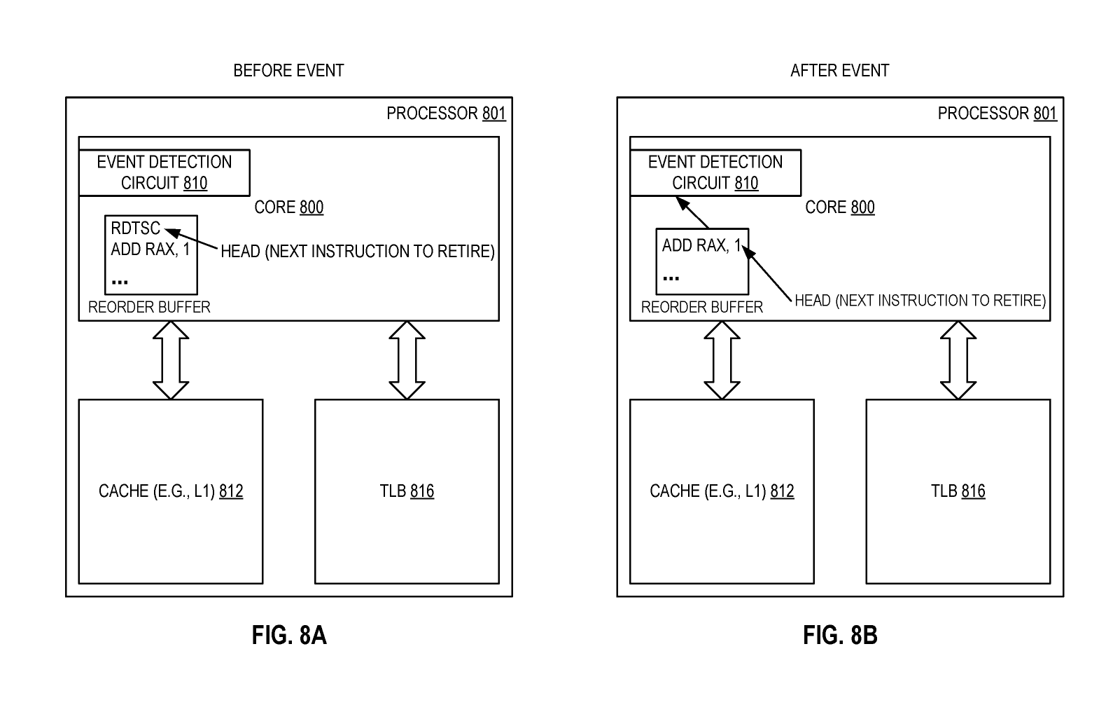

FIG. 8A illustrates a processor 801 before a software selected precursor (for example, execution or retirement of an instruction that returns a time stamp counter, e.g., as detected with event detection circuit 810 of core 800) of occurs according to embodiments of the disclosure. Note that in certain embodiments, the example event (e.g., retirement of RDTSC), occurs as a direct consequence of executing an instruction, and hence is placed in Group 6; this may occur in a function called from a transaction. The meaning and usage of one or more instructions (e.g., including RDTSC) may change from one implementation of processor to another, for example, in a virtual machine, RDTSC may provide a processor with some synthesized version of time instead of the exact cycle count that it may yield in a non-virtualized execution. FIG. 8B illustrates the processor 801 of FIG. 8A after the software selected precursor occurs according to embodiments of the disclosure. The hardware transactional circuit (not depicted) may then take an action based on that detection, for example, any of the four options (1)-(4) discussed above. In the depicted embodiment, processor 801 includes a cache 812 and TLB 816.

FIGS. 9A-9B illustrate precursors according to embodiments of the disclosure. The term baseline in reference to FIGS. 9A-9B generally refers to memory access conflicts. Precursors may be events or conditions (e.g., C₀, C₁ . . . C_{K-1}) under which a transaction aborts on the baseline. Further let C_{K}, C_{K+1} . . . C_{N-1} describe a set of conditions which do not cause an abort on the baseline, but are possible reasons to consider aborting a transaction. In reference to FIGS. 9A-9B, for example, the term precursor may generally refer to a condition or set of conditions which factors into a decision to abort a transaction, e.g., either by a hardware transactional circuit (e.g., a hardware transactional execution circuit thereof) or by software code executing, e.g., interfacing with a hardware transactional execution circuit. In one embodiment, the enablement (e.g., turning on) of detection of a software selected precursor is the same as the enablement of HTM hardware, e.g., enabling the HTM hardware enables the hardware transactional circuit to detect (and take other action(s) or not) a precursor.

In the tables in FIGS. 9A-9B, up to 64 precursors may be utilized. In other embodiments, the number of precursors may be one or any plurality. In reference to FIGS. 9A-9B, Table 1 below provides for embodiments of groups of software selectable precursors and other terminology.

TABLE 1
Embodiments of Groups of Software Selectable
Precursors and Other Terminology

| | |
|---|---|
| TXN: | A transaction |
| HTX: | A hardware synchronized transaction |
| RSET: | Set of (e.g., L1) cache lines that have been read from a CPU |
| | (e.g., core) while it is in an HTX |
| WSET: | Set of (e.g., L1) cache lines that a CPU (e.g., core) has written |
| | while in an HTX |
| TSET: | Set of virtual pages from each of which at least one cache |
| | line is in the RSET or WSET |
| CSET: | An architecturally defined logical collection of bits from |
| | different control and status register (CSR) and/or model- |
| | specific register (MSR) in a particular implementation |
| | (e.g., of CPUs or cores). Which CSRs/MSRs, and which |
| | collection of bits from them are included in the CSET |
| | may change with implementations and may be fixed |
| | for a given implementation of a CPU (e.g., core) |
| DSET: | Status flags from communication/storage devices |
| | indicating either non-empty receive queues, or new |
| | send event completions from transmit operations |
| PSET: | A group of performance monitoring unit (PMU) events, |
| | each of which is considered as TRUE during an HTX if |
| | a particular performance monitoring (PMON) event counter |
| | overflows (e.g., crosses a threshold value specified for it |
| | by software). Since the total number of PMU events may |
| | be very large, some number of virtual events may be |
| | selected by software, e.g., and configured into PSET |
| | through new instruction(s) |
| ISET: | Executions of certain (e.g., a subset of) instructions that |
| | are considered to be non-aborting in the baseline, but are |
| | possible precursors |

In certain embodiments herein, a hardware transactional circuit includes an interface with software to set the precursor(s) and/or control the actions taken in response to the precursor(s) detection. For example, one or more (e.g., control) registers may be utilized as the interface. Although the below discussion refers to three control registers, a single or any plurality of control registers may be used in certain embodiments. In this embodiment, a first control register is to store a (e.g., 128-bit) vector (e.g., HT_EVENTS_MASK) that provides two bits per precursor. For each precursor in this embodiment, these two bits (e.g., 00, 01, 10, and 11) permit the selection of one of the options (e.g., the four different options (1)-(4) discussed above) for the way(s) the hardware transactional circuit handles the transaction during which that precursor arises. In this embodiment, a second control register is to store a multiple (e.g., 64) bit flag (e.g., HT_EVENTS_FLAG) to capture precursors that arise during execution of the transactions being monitored, for example, the flags are initialized to zero (e.g., by the hardware) at the start of a transaction, with each precursor occurrence causing a bit to be set (e.g., high). In this embodiment, a third control register is to store a (e.g., 64) bit mask (e.g., HT_ABORT_MASK) used by the hardware transactional circuit, for example, such that the circuit aborts the transaction when either the bitwise AND of the contents of the second and third registers (e.g., HT_EVENTS_FLAG & HT_ABORT_MASK) matches HT_ABORT_MASK or the dispositions specified by software in HT_EVENTS_MASK force an immediate abort. In one embodiment, the use of HT_ABORT_MASK together with HT_EVENTS_FLAG permits software to indicate to hardware that under some mix of criteria a speculative transaction should be aborted, for example, one such criterion is “the number of instructions executed is above a first threshold, and the number of cachelines modified by the transaction is above a second threshold”. The use of HT_EVENTS_MASK on the other hand in certain embodiments permits software to set certain policies under which transactions may be discontinued, for example, when software wants to enforce strict snapshot isolation between concurrent threads for certain kinds of transactions.

Turning back to FIGS. 9A-9B, the term storage class memory (SCM) generally refers to persistent memory (e.g., directly addressed storage class memory). In one embodiment, storage class memory is a non-volatile memory (NVM) that includes dynamic, random access memory-like performance and storage-like non-volatility. An example of a storage class memory is a phase change memory with an access device. Other examples include ferroelectric random access memory, magnetoresistive memory, resistive random access memory, programmable metallization cell memory, and nano-wire based charge trapping memories.

In one embodiment, one or more of precursors (e.g., C₅-C₆₃) do not affect the continuity of an HTM transaction, but it may be desirable to heed these events in advanced transaction constructions.

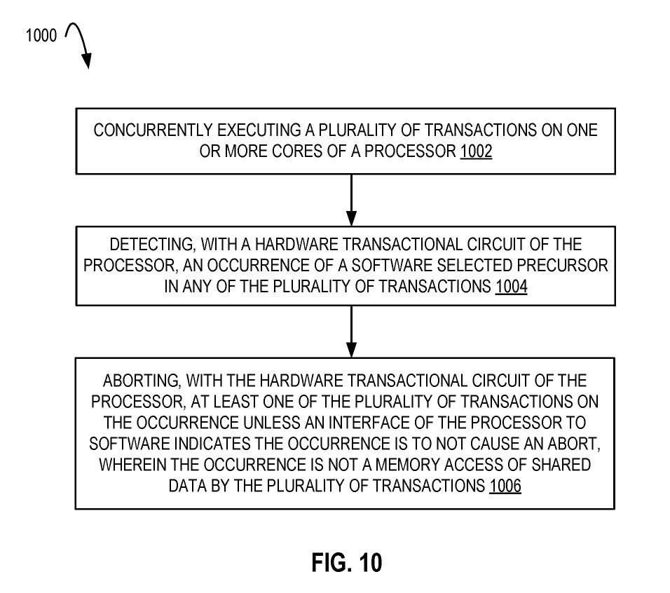

FIG. 10 illustrates a flow diagram 1000 according to embodiments of the disclosure. Flow 1000 includes concurrently executing a plurality of transactions on one or more cores of a processor 1002, detecting, with a hardware transactional circuit of the processor, an occurrence of a software selected precursor in any of the plurality of transactions 1004, and aborting, with the hardware transactional circuit of the processor, at least one of the plurality of transactions on the occurrence unless an interface of the processor to software indicates the occurrence is to not cause an abort, wherein the occurrence is not a memory access of shared data by the plurality of transactions 1006.

In one embodiment, a processor includes one or more cores to concurrently execute a plurality of transactions, and a hardware transactional circuit to detect an occurrence of a software selected precursor in any of the plurality of transactions and abort at least one of the plurality of transactions on the occurrence unless an interface to software indicates the occurrence is to not cause an abort, wherein the occurrence is not a memory access of shared data by the plurality of transactions. The hardware transactional circuit may also abort on a detection of the memory access of shared data by the plurality of transactions. The hardware transactional circuit may store a log of events about the occurrence of the software selected precursor when the occurrence is detected. The software may determine when to abort based on the log and indicate to the interface to perform the abort. The hardware transactional circuit may store a log of events about each occurrence of multiple software selected precursors when each occurrence is detected. The software may determine when to abort based on the log and indicate to the interface to perform the abort. The software selected precursor may be a maximum cache miss rate of a transaction. The hardware transactional circuit may detect the occurrence of the software selected precursor in any of the plurality of transactions, and cause, for at least one of the plurality of transactions, one of a performance of the abort, a store of a log of events about the occurrence, and not perform either of the abort and the store.

In another embodiment, a method includes concurrently executing a plurality of transactions on one or more cores of a processor, detecting, with a hardware transactional circuit of the processor, an occurrence of a software selected precursor in any of the plurality of transactions, and aborting, with the hardware transactional circuit of the processor, at least one of the plurality of transactions on the occurrence unless an interface of the processor to software indicates the occurrence is to not cause an abort, wherein the occurrence is not a memory access of shared data by the plurality of transactions. The method may further include also aborting, with the hardware transactional circuit of the processor, on the detection of the memory access of shared data by the plurality of transactions. The method may further include storing, with the hardware transactional circuit of the processor, a log of events about the occurrence of the software selected precursor when the occurrence is detected. The method may further include the software determining when to abort based on the log and indicating to the interface to perform the abort. The method may further include storing, with the hardware transactional circuit of the processor, a log of events about each occurrence of multiple software selected precursors when each occurrence is detected. The method may further include the software determining when to abort based on the log and indicating to the interface to perform the abort. The method may further include wherein the software selected precursor is a maximum cache miss rate of a transaction. The method may further include detecting, with the hardware transactional circuit of the processor, the occurrence of the software selected precursor in any of the plurality of transactions, and causing, for at least one of the plurality of transactions, one of the aborting, storing of a log of events about the occurrence, and not performing either of the abort and the store.

In yet another embodiment, a system includes a memory, and a processor comprising one or more cores to concurrently execute a plurality of transactions, and a hardware transactional circuit to detect an occurrence of a software selected precursor in any of the plurality of transactions and abort at least one of the plurality of transactions on the occurrence unless an interface to software indicates the occurrence is to not cause an abort, wherein the occurrence is not a memory access of shared data in the memory by the plurality of transactions. The hardware transactional circuit may also cause an abort on a detection of the memory access of shared data in the memory by the plurality of transactions. The hardware transactional circuit may store a log of events about the occurrence of the software selected precursor when the occurrence is detected. The software may determine when to abort based on the log and indicate to the interface to perform the abort. The hardware transactional circuit may store a log of events about each occurrence of multiple software selected precursors when each occurrence is detected. The software may determine when to abort based on the log and indicate to the interface to perform the abort. The software selected precursor may be a maximum cache miss rate of a transaction. The hardware transactional circuit may detect the occurrence of the software selected precursor in any of the plurality of transactions, and cause, for at least one of the plurality of transactions, one of a performance of the abort, a store of a log of events about the occurrence, and not perform either of the abort and the store.

In another embodiment, a processor includes one or more cores to concurrently execute a plurality of transactions, and hardware means to detect an occurrence of a software selected precursor in any of the plurality of transactions and abort at least one of the plurality of transactions on the occurrence unless an interface to software indicates the occurrence is to not cause an abort, wherein the occurrence is not a memory access of shared data by the plurality of transactions.

In yet another embodiment, an apparatus comprises a data storage device that stores code that when executed by a hardware processor causes the hardware processor to perform any method disclosed herein. An apparatus may be as described in the detailed description. A method may be as described in the detailed description.

In another embodiment, a non-transitory machine readable medium that stores code that when executed by a machine causes the machine to perform a method comprising any method disclosed herein.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, April 2016; and see Intel® Architecture Instruction Set Extensions Programming Reference, February 2016).

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

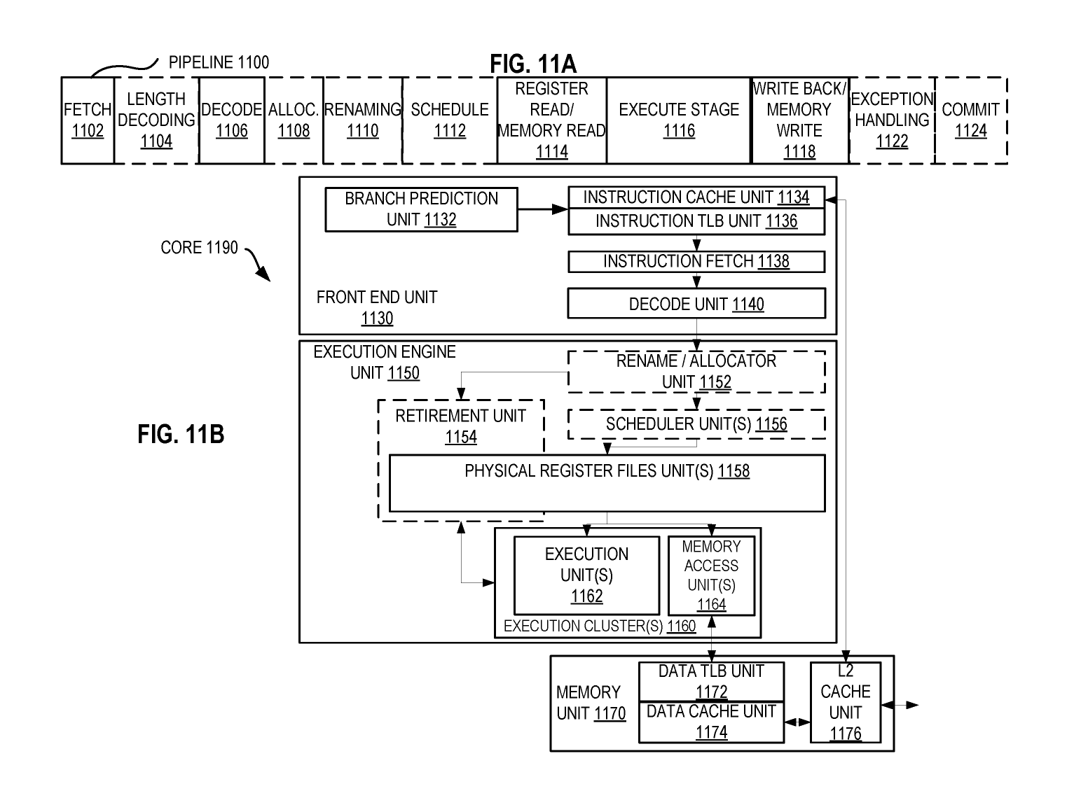

FIG. 11A is a block diagram illustrating both an exemplary in-order pipeline and an exemplary register renaming, out-of-order issue/execution pipeline according to embodiments of the disclosure. FIG. 11B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 11A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11A, a processor pipeline 1100 includes a fetch stage 1102, a length decode stage 1104, a decode stage 1106, an allocation stage 1108, a renaming stage 1110, a scheduling (also known as a dispatch or issue) stage 1112, a register read/memory read stage 1114, an execute stage 1116, a write back/memory write stage 1118, an exception handling stage 1122, and a commit stage 1124.

FIG. 11B shows processor core 1190 including a front end unit 1130 coupled to an execution engine unit 1150, and both are coupled to a memory unit 1170. The core 1190 may be a reduced instruction set computing (RISC) core, a complex instruction set computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front end unit 1130 includes a branch prediction unit 1132 coupled to an instruction cache unit 1134, which is coupled to an instruction translation lookaside buffer (TLB) 1136, which is coupled to an instruction fetch unit 1138, which is coupled to a decode unit 1140. The decode unit 1140 (or decoder or decoder unit) may decode instructions (e.g., macro-instructions), and generate as an output one or more micro-operations, micro-code entry points, micro-instructions, other instructions, or other control signals, which are decoded from, or which otherwise reflect, or are derived from, the original instructions. The decode unit 1140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1190 includes a microcode ROM or other medium that stores microcode for certain macroinstructions (e.g., in decode unit 1140 or otherwise within the front end unit 1130). The decode unit 1140 is coupled to a rename/allocator unit 1152 in the execution engine unit 1150.

The execution engine unit 1150 includes the rename/allocator unit 1152 coupled to a retirement unit 1154 and a set of one or more scheduler unit(s) 1156. The scheduler unit(s) 1156 represents any number of different schedulers, including reservations stations, central instruction window, etc. The scheduler unit(s) 1156 is coupled to the physical register file(s) unit(s) 1158. Each of the physical register file(s) units 1158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1158 comprises a vector registers unit, a write mask registers unit, and a scalar registers unit. These register units may provide architectural vector registers, vector mask registers, and general purpose registers. The physical register file(s) unit(s) 1158 is overlapped by the retirement unit 1154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1154 and the physical register file(s) unit(s) 1158 are coupled to the execution cluster(s) 1160. The execution cluster(s) 1160 includes a set of one or more execution units 1162 and a set of one or more memory access units 1164. The execution units 1162 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1156, physical register file(s) unit(s) 1158, and execution cluster(s) 1160 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1164). It should also be understood that where separate pipelines are used, one or more of these pipelines may be out-of-order issue/execution and the rest in-order.

The set of memory access units 1164 is coupled to the memory unit 1170, which includes a data TLB unit 1172 coupled to a data cache unit 1174 coupled to a level 2 (L2) cache unit 1176. In one exemplary embodiment, the memory access units 1164 may include a load unit, a store address unit, and a store data unit, each of which is coupled to the data TLB unit 1172 in the memory unit 1170. The instruction cache unit 1134 is further coupled to a level 2 (L2) cache unit 1176 in the memory unit 1170. The L2 cache unit 1176 is coupled to one or more other levels of cache and eventually to a main memory.

By way of example, the exemplary register renaming, out-of-order issue/execution core architecture may implement the pipeline 1100 as follows: 1) the instruction fetch 1138 performs the fetch and length decoding stages 1102 and 1104; 2) the decode unit 1140 performs the decode stage 1106; 3) the rename/allocator unit 1152 performs the allocation stage 1108 and renaming stage 1110; 4) the scheduler unit(s) 1156 performs the schedule stage 1112; 5) the physical register file(s) unit(s) 1158 and the memory unit 1170 perform the register read/memory read stage 1114; the execution cluster 1160 perform the execute stage 1116; 6) the memory unit 1170 and the physical register file(s) unit(s) 1158 perform the write back/memory write stage 1118; 7) various units may be involved in the exception handling stage 1122; and 8) the retirement unit 1154 and the physical register file(s) unit(s) 1158 perform the commit stage 1124.

The core 1190 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1190 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1134/1174 and a shared L2 cache unit 1176, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary in-Order Core Architecture

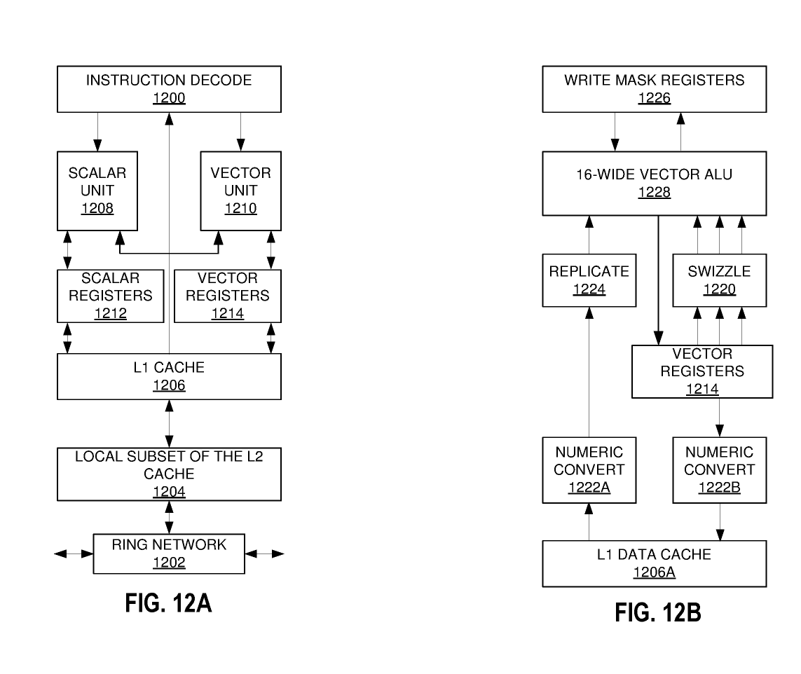

FIGS. 12A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 12A is a block diagram of a single processor core, along with its connection to the on-die interconnect network 1202 and with its local subset of the Level 2 (L2) cache 1204, according to embodiments of the disclosure. In one embodiment, an instruction decode unit 1200 supports the x86 instruction set with a packed data instruction set extension. An L1 cache 1206 allows low-latency accesses to cache memory into the scalar and vector units. While in one embodiment (to simplify the design), a scalar unit 1208 and a vector unit 1210 use separate register sets (respectively, scalar registers 1212 and vector registers 1214) and data transferred between them is written to memory and then read back in from a level 1 (L1) cache 1206, alternative embodiments of the disclosure may use a different approach (e.g., use a single register set or include a communication path that allows data to be transferred between the two register files without being written and read back).

The local subset of the L2 cache 1204 is part of a global L2 cache that is divided into separate local subsets, one per processor core. Each processor core has a direct access path to its own local subset of the L2 cache 1204. Data read by a processor core is stored in its L2 cache subset 1204 and can be accessed quickly, in parallel with other processor cores accessing their own local L2 cache subsets. Data written by a processor core is stored in its own L2 cache subset 1204 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 12B is an expanded view of part of the processor core in FIG. 12A according to embodiments of the disclosure. FIG. 12B includes an L1 data cache 1206A part of the L1 cache 1204, as well as more detail regarding the vector unit 1210 and the vector registers 1214. Specifically, the vector unit 1210 is a 16-wide vector processing unit (VPU) (see the 16-wide ALU 1228), which executes one or more of integer, single-precision float, and double-precision float instructions. The VPU supports swizzling the register inputs with swizzle unit 1220, numeric conversion with numeric convert units 1222A-B, and replication with replication unit 1224 on the memory input. Write mask registers 1226 allow predicating resulting vector writes.

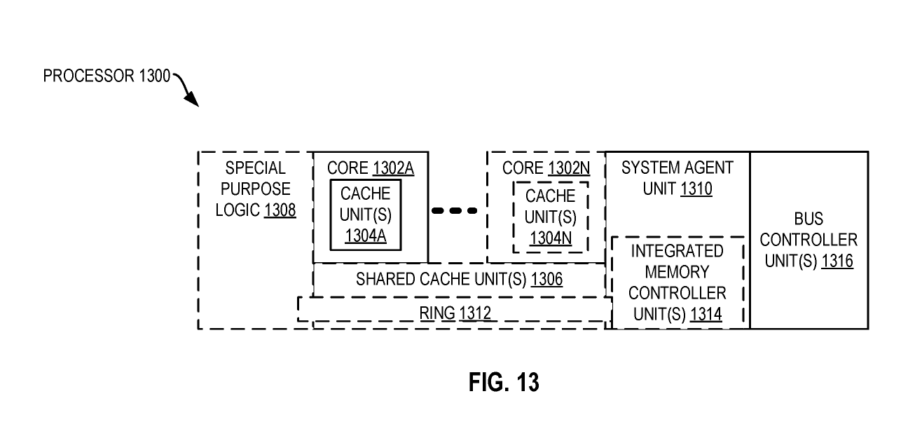

FIG. 13 is a block diagram of a processor 1300 that may have more than one core, may have an integrated memory controller, and may have integrated graphics according to embodiments of the disclosure. The solid lined boxes in FIG. 13 illustrate a processor 1300 with a single core 1302A, a system agent 1310, a set of one or more bus controller units 1316, while the optional addition of the dashed lined boxes illustrates an alternative processor 1300 with multiple cores 1302A-N, a set of one or more integrated memory controller unit(s) 1314 in the system agent unit 1310, and special purpose logic 1308.

Thus, different implementations of the processor 1300 may include: 1) a CPU with the special purpose logic 1308 being integrated graphics and/or scientific (throughput) logic (which may include one or more cores), and the cores 1302A-N being one or more general purpose cores (e.g., general purpose in-order cores, general purpose out-of-order cores, a combination of the two); 2) a coprocessor with the cores 1302A-N being a large number of special purpose cores intended primarily for graphics and/or scientific (throughput); and 3) a coprocessor with the cores 1302A-N being a large number of general purpose in-order cores. Thus, the processor 1300 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1306, and external memory (not shown) coupled to the set of integrated memory controller units 1314. The set of shared cache units 1306 may include one or more mid-level caches, such as level 2 (L2), level 3 (L3), level 4 (L4), or other levels of cache, a last level cache (LLC), and/or combinations thereof. While in one embodiment a ring based interconnect unit 1312 interconnects the integrated graphics logic 1308, the set of shared cache units 1306, and the system agent unit 1310/integrated memory controller unit(s) 1314, alternative embodiments may use any number of well-known techniques for interconnecting such units. In one embodiment, coherency is maintained between one or more cache units 1306 and cores 1302-A-N.

In some embodiments, one or more of the cores 1302A-N are capable of multi-threading. The system agent 1310 includes those components coordinating and operating cores 1302A-N. The system agent unit 1310 may include for example a power control unit (PCU) and a display unit. The PCU may be or include logic and components needed for regulating the power state of the cores 1302A-N and the integrated graphics logic 1308. The display unit is for driving one or more externally connected displays.

The cores 1302A-N may be homogenous or heterogeneous in terms of architecture instruction set; that is, two or more of the cores 1302A-N may be capable of executing the same instruction set, while others may be capable of executing only a subset of that instruction set or a different instruction set.

### Exemplary Computer Architectures

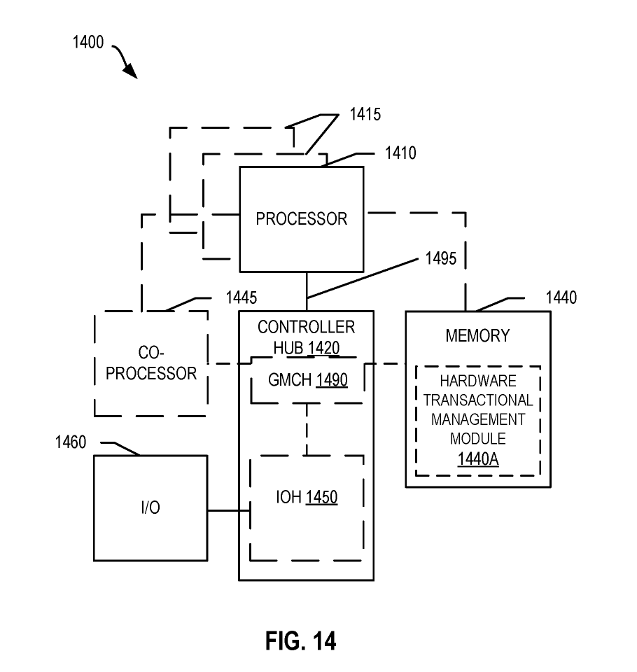

FIGS. 14-17 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 14, shown is a block diagram of a system 1400 in accordance with one embodiment of the present disclosure. The system 1400 may include one or more processors 1410, 1415, which are coupled to a controller hub 1420. In one embodiment the controller hub 1420 includes a graphics memory controller hub (GMCH) 1490 and an Input/Output Hub (IOH) 1450 (which may be on separate chips); the GMCH 1490 includes memory and graphics controllers to which are coupled memory 1440 and a coprocessor 1445; the IOH 1450 is couples input/output (I/O) devices 1460 to the GMCH 1490. Alternatively, one or both of the memory and graphics controllers are integrated within the processor (as described herein), the memory 1440 and the coprocessor 1445 are coupled directly to the processor 1410, and the controller hub 1420 in a single chip with the IOH 1450. Memory 1440 may include a hardware transactional management module 1440A, for example, to store code that when executed causes a processor to perform any method of this disclosure.

The optional nature of additional processors 1415 is denoted in FIG. 14 with broken lines. Each processor 1410, 1415 may include one or more of the processing cores described herein and may be some version of the processor 1300.

The memory 1440 may be, for example, dynamic random access memory (DRAM), phase change memory (PCM), or a combination of the two. For at least one embodiment, the controller hub 1420 communicates with the processor(s) 1410, 1415 via a multi-drop bus, such as a frontside bus (FSB), point-to-point interface such as QuickPath Interconnect (QPI), or similar connection 1495.

In one embodiment, the coprocessor 1445 is a special-purpose processor, such as, for example, a high-throughput MIC processor, a network or communication processor, compression engine, graphics processor, GPGPU, embedded processor, or the like. In one embodiment, controller hub 1420 may include an integrated graphics accelerator.

There can be a variety of differences between the physical resources 1410, 1415 in terms of a spectrum of metrics of merit including architectural, microarchitectural, thermal, power consumption characteristics, and the like.

In one embodiment, the processor 1410 executes instructions that control data processing operations of a general type. Embedded within the instructions may be coprocessor instructions. The processor 1410 recognizes these coprocessor instructions as being of a type that should be executed by the attached coprocessor 1445. Accordingly, the processor 1410 issues these coprocessor instructions (or control signals representing coprocessor instructions) on a coprocessor bus or other interconnect, to coprocessor 1445. Coprocessor(s) 1445 accept and execute the received coprocessor instructions.

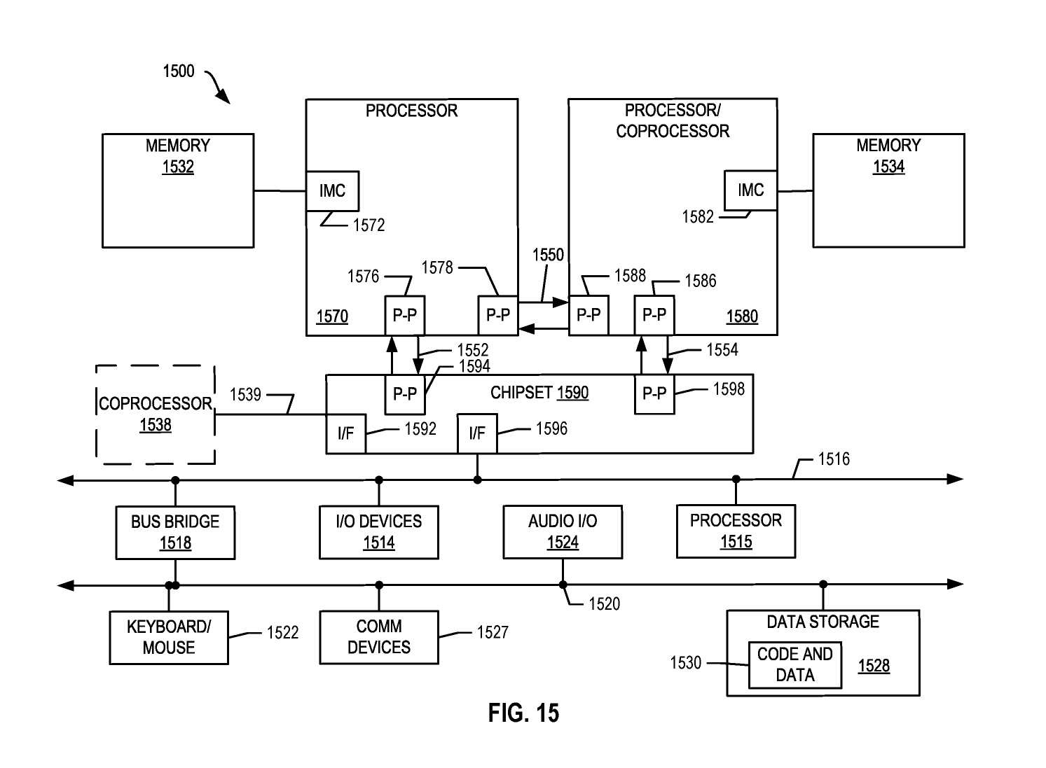

Referring now to FIG. 15, shown is a block diagram of a first more specific exemplary system 1500 in accordance with an embodiment of the present disclosure. As shown in FIG. 15, multiprocessor system 1500 is a point-to-point interconnect system, and includes a first processor 1570 and a second processor 1580 coupled via a point-to-point interconnect 1550. Each of processors 1570 and 1580 may be some version of the processor 1300. In one embodiment of the disclosure, processors 1570 and 1580 are respectively processors 1410 and 1415, while coprocessor 1538 is coprocessor 1445. In another embodiment, processors 1570 and 1580 are respectively processor 1410 coprocessor 1445.

Processors 1570 and 1580 are shown including integrated memory controller (IMC) units 1572 and 1582, respectively. Processor 1570 also includes as part of its bus controller units point-to-point (P-P) interfaces 1576 and 1578; similarly, second processor 1580 includes P-P interfaces 1586 and 1588. Processors 1570, 1580 may exchange information via a point-to-point (P-P) interface 1550 using P-P interface circuits 1578, 1588. As shown in FIG. 15, IMCs 1572 and 1582 couple the processors to respective memories, namely a memory 1532 and a memory 1534, which may be portions of main memory locally attached to the respective processors.

Processors 1570, 1580 may each exchange information with a chipset 1590 via individual P-P interfaces 1552, 1554 using point to point interface circuits 1576, 1594, 1586, 1598. Chipset 1590 may optionally exchange information with the coprocessor 1538 via a high-performance interface 1539. In one embodiment, the coprocessor 1538 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1590 may be coupled to a first bus 1516 via an interface 1596. In one embodiment, first bus 1516 may be a Peripheral Component Interconnect (PCI) bus, or a bus such as a PCI Express bus or another third generation I/O interconnect bus, although the scope of the present disclosure is not so limited.

As shown in FIG. 15, various I/O devices 1514 may be coupled to first bus 1516, along with a bus bridge 1518 which couples first bus 1516 to a second bus 1520. In one embodiment, one or more additional processor(s) 1515, such as coprocessors, high-throughput MIC processors, GPGPU's, accelerators (such as, e.g., graphics accelerators or digital signal processing (DSP) units), field programmable gate arrays, or any other processor, are coupled to first bus 1516. In one embodiment, second bus 1520 may be a low pin count (LPC) bus. Various devices may be coupled to a second bus 1520 including, for example, a keyboard and/or mouse 1522, communication devices 1527 and a storage unit 1528 such as a disk drive or other mass storage device which may include instructions/code and data 1530, in one embodiment. Further, an audio I/O 1524 may be coupled to the second bus 1520. Note that other architectures are possible. For example, instead of the point-to-point architecture of FIG. 15, a system may implement a multi-drop bus or other such architecture.

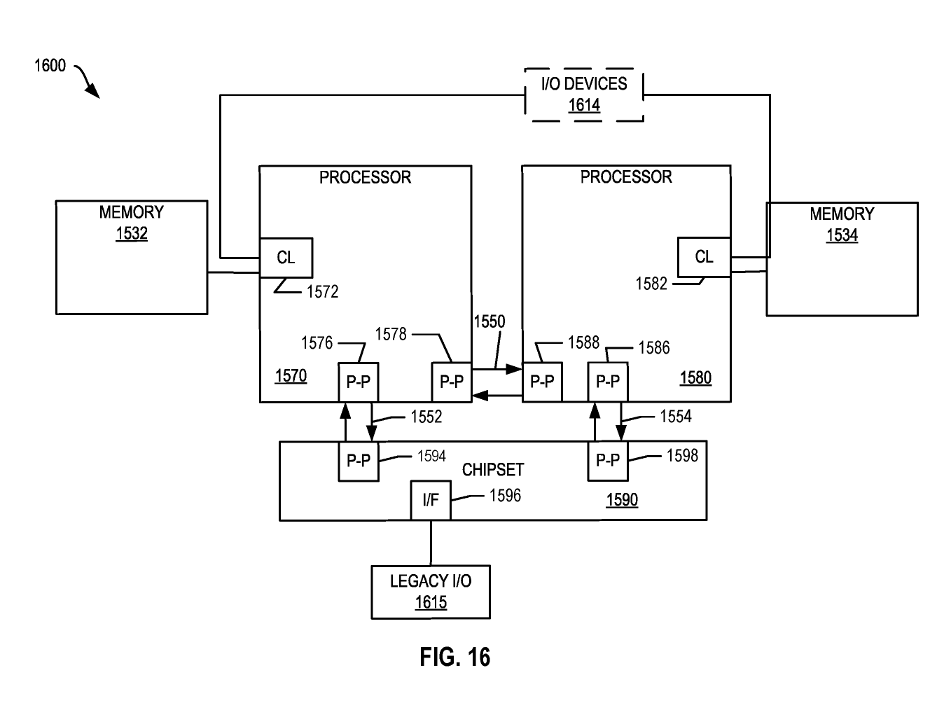

Referring now to FIG. 16, shown is a block diagram of a second more specific exemplary system 1600 in accordance with an embodiment of the present disclosure Like elements in FIGS. 15 and 16 bear like reference numerals, and certain aspects of FIG. 15 have been omitted from FIG. 16 in order to avoid obscuring other aspects of FIG. 16.

FIG. 16 illustrates that the processors 1570, 1580 may include integrated memory and I/O control logic (“CL”) 1572 and 1582, respectively. Thus, the CL 1572, 1582 include integrated memory controller units and include I/O control logic. FIG. 16 illustrates that not only are the memories 1532, 1534 coupled to the CL 1572, 1582, but also that I/O devices 1614 are also coupled to the control logic 1572, 1582. Legacy I/O devices 1615 are coupled to the chipset 1590.

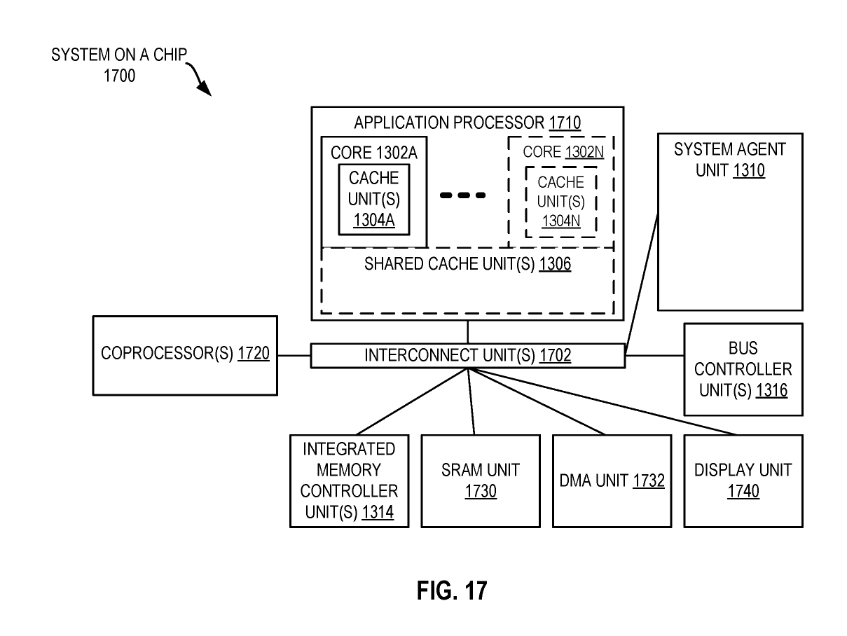

Referring now to FIG. 17, shown is a block diagram of a SoC 1700 in accordance with an embodiment of the present disclosure. Similar elements in FIG. 13 bear like reference numerals. Also, dashed lined boxes are optional features on more advanced SoCs. In FIG. 17, an interconnect unit(s) 1702 is coupled to: an application processor 1710 which includes a set of one or more cores 202A-N and shared cache unit(s) 1306; a system agent unit 1310; a bus controller unit(s) 1316; an integrated memory controller unit(s) 1314; a set or one or more coprocessors 1720 which may include integrated graphics logic, an image processor, an audio processor, and a video processor; an static random access memory (SRAM) unit 1730; a direct memory access (DMA) unit 1732; and a display unit 1740 for coupling to one or more external displays. In one embodiment, the coprocessor(s) 1720 include a special-purpose processor, such as, for example, a network or communication processor, compression engine, GPGPU, a high-throughput MIC processor, embedded processor, or the like.

Embodiments (e.g., of the mechanisms) disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 1530 illustrated in FIG. 15, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores”, may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

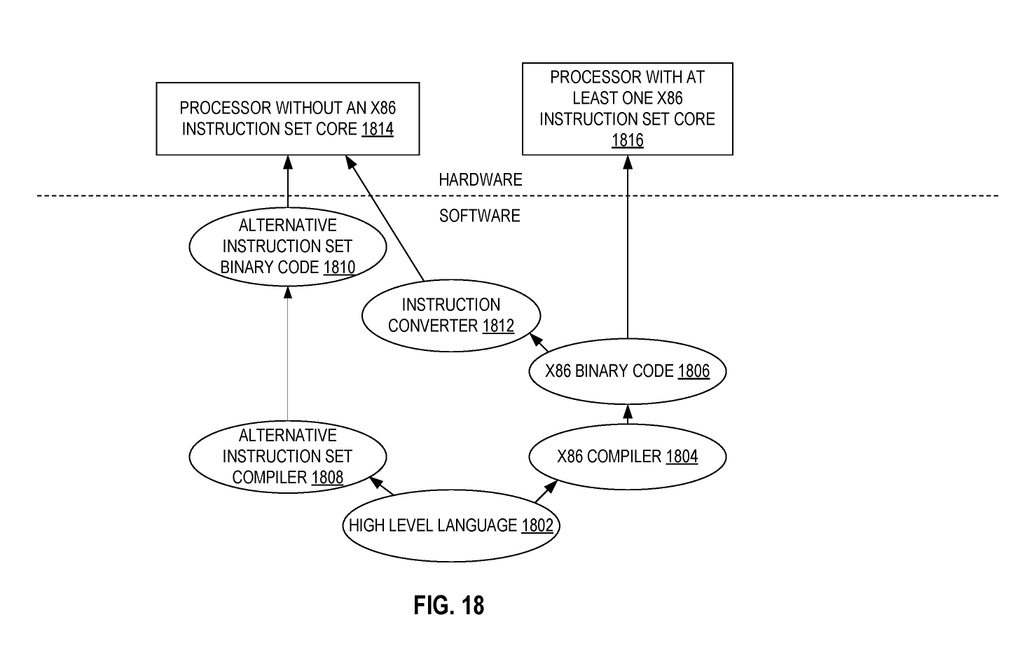

FIG. 18 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 18 shows a program in a high level language 1802 may be compiled using an x86 compiler 1804 to generate x86 binary code 1806 that may be natively executed by a processor with at least one x86 instruction set core 1816. The processor with at least one x86 instruction set core 1816 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1804 represents a compiler that is operable to generate x86 binary code 1806 (e.g., object code) that can, with or without additional linkage processing, be executed on the processor with at least one x86 instruction set core 1816. Similarly, FIG. 18 shows the program in the high level language 1802 may be compiled using an alternative instruction set compiler 1808 to generate alternative instruction set binary code 1810 that may be natively executed by a processor without at least one x86 instruction set core 1814 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1812 is used to convert the x86 binary code 1806 into code that may be natively executed by the processor without an x86 instruction set core 1814. This converted code is not likely to be the same as the alternative instruction set binary code 1810 because an instruction converter capable of this is difficult to make; however, the converted code will accomplish the general operation and be made up of instructions from the alternative instruction set. Thus, the instruction converter 1812 represents software, firmware, hardware, or a combination thereof that, through emulation, simulation or any other process, allows a processor or other electronic device that does not have an x86 instruction set processor or core to execute the x86 binary code 1806.

What is claimed is:

1. A processor comprising:
one or more cores to concurrently execute a plurality of transactions; and
a hardware transactional circuit to detect an occurrence of a software selected precursor in any of the plurality of transactions and abort at least one of the plurality of transactions on the occurrence unless an interface to software indicates the occurrence is to not cause an abort, wherein the occurrence is not a memory access of shared data by the plurality of transactions.

2. The processor of claim 1, wherein the hardware transactional circuit is also to abort on a detection of the memory access of shared data by the plurality of transactions.

3. The processor of claim 1, wherein the hardware transactional circuit is to store a log of events about the occurrence of the software selected precursor when the occurrence is detected.

4. The processor of claim 3, wherein the software is to determine when to abort based on the log and indicate to the interface to perform the abort.

5. The processor of claim 1, wherein the hardware transactional circuit is to store a log of events about each occurrence of multiple software selected precursors when each occurrence is detected.

6. The processor of claim 5, wherein the software is to determine when to abort based on the log and indicate to the interface to perform the abort.

7. The processor of claim 1, wherein the software selected precursor is a maximum cache miss rate of a transaction.

8. The processor of claim 1, wherein the hardware transactional circuit is to:
detect the occurrence of the software selected precursor in any of the plurality of transactions, and
cause, for at least one of the plurality of transactions, one of a performance of the abort, a store of a log of events about the occurrence, and not perform either of the abort and the store.

9. A method comprising:
concurrently executing a plurality of transactions on one or more cores of a processor;
detecting, with a hardware transactional circuit of the processor, an occurrence of a software selected precursor in any of the plurality of transactions; and
aborting, with the hardware transactional circuit of the processor, at least one of the plurality of transactions on the occurrence unless an interface of the processor to software indicates the occurrence is to not cause an abort, wherein the occurrence is not a memory access of shared data by the plurality of transactions.

10. The method of claim 9, further comprising also aborting, with the hardware transactional circuit of the processor, on the detection of the memory access of shared data by the plurality of transactions.

11. The method of claim 9, further comprising storing, with the hardware transactional circuit of the processor, a log of events about the occurrence of the software selected precursor when the occurrence is detected.

12. The method of claim 11, wherein the software determines when to abort based on the log and indicates to the interface to perform the abort.

13. The method of claim 9, further comprising storing, with the hardware transactional circuit of the processor, a log of events about each occurrence of multiple software selected precursors when each occurrence is detected.

14. The method of claim 13, wherein the software determines when to abort based on the log and indicates to the interface to perform the abort.

15. The method of claim 9, wherein the software selected precursor is a maximum cache miss rate of a transaction.

16. The method of claim 9, further comprising:
detecting, with the hardware transactional circuit of the processor, the occurrence of the software selected precursor in any of the plurality of transactions, and
causing, for at least one of the plurality of transactions, one of the aborting, storing of a log of events about the occurrence, and not performing either of the abort and the store.

17. A system comprising:
a memory; and
a processor comprising:
one or more cores to concurrently execute a plurality of transactions, and
a hardware transactional circuit to detect an occurrence of a software selected precursor in any of the plurality of transactions and abort at least one of the plurality of transactions on the occurrence unless an interface to software indicates the occurrence is to not cause an abort, wherein the occurrence is not a memory access of shared data in the memory by the plurality of transactions.

18. The system of claim 17, wherein the hardware transactional circuit is also to abort on a detection of the memory access of shared data in the memory by the plurality of transactions.

19. The system of claim 17, wherein the hardware transactional circuit is to store a log of events about the occurrence of the software selected precursor when the occurrence is detected.

20. The system of claim 19, wherein the software is to determine when to abort based on the log and indicate to the interface to perform the abort.

21. The system of claim 17, wherein the hardware transactional circuit is to store a log of events about each occurrence of multiple software selected precursors when each occurrence is detected.

22. The system of claim 21, wherein the software is to determine when to abort based on the log and indicate to the interface to perform the abort.

23. The system of claim 17, wherein the software selected precursor is a maximum cache miss rate of a transaction.

24. The system of claim 17, wherein the hardware transactional circuit is to:
detect the occurrence of the software selected precursor in any of the plurality of transactions, and
cause, for at least one of the plurality of transactions, one of a performance of the abort, a store of a log of events about the occurrence, and not perform either of the abort and the store.
